(19) United States
(12) Patent Application Publication
(10) Pub. No.: US 2023/0237796 A1
(43) Pub. Date: Jul. 27, 2023

(54) GEO-SPATIAL CONTEXT FOR FULL-MOTION VIDEO

(71) Applicant: Cubic Corporation, San Diego, CA (US)

(72) Inventors: Dimitrije Misic, Nis (RS); Nemanja Grujic, Nis (RS); Milan Markovic, Nis (RS)

(73) Assignee: Cubic Corporation, San Diego, CA (US)

(21) Appl. No.: 18/158,886

(22) Filed: Jan. 24, 2023

Related U.S. Application Data
(60) Provisional application No. 63/302,972, filed on Jan. 25, 2022.

(51) Int. Cl. G06V 20/10; G06T 3/40; G06T 3/60; G06V 10/24; G06V 20/17; H04N 5/265

(52) U.S. Cl. CPC G06V 20/176; G06T 3/40; G06T 3/608; G06V 10/24; G06V 20/17; H04N 5/265

(57) ABSTRACT

A method and a system for generating a composite video feed for a geographical area are disclosed. A video of the geographical area, captured by a camera, of an aerial platform is received. The video includes metadata indicative of location information, which is used to identify the coordinates of the geographical area. An image that is adjacent to the geographical area is received from the geographical information system and is transformed according to the metadata. The coordinates of the geographical area are used to determine an area with the image. The video is embedded in the area by matching the area with the coordinates of the geographical area, where the edges of the video correspond to the boundaries of the area. A composite video feed, including the video embedded along with the image, is generated and a video player displays the composite video feed.

This application claims the benefit of and is a non-provisional of co-pending U.S. Provisional Application Ser. No. 63/302,972 filed on Jan. 25, 2022, which is hereby expressly incorporated by reference in its entirety for all purposes.

### BACKGROUND

This disclosure generally relates to a system and a method and, not by way of limitation, to generate a composite video feed for a geographical area.

For providing a web mapping service, various platforms are designed to serve geo-referenced images over the Internet. The geo-referenced images are then displayed on a display device connected to the platforms. The geo-referenced images are typically retrieved from a data center associated with a Geographical Information System (GIS). Further, the platforms are designed to provide a 3D representation of imagery stored in the data center. To achieve this, satellite images, aerial photography, and GIS data are superimposed onto a 3D geographical region. Furthermore, the platforms provide options to modify views of the 3D geographical region to allow users to see landscapes on the display device from various angles or positions.

### SUMMARY

In one embodiment, a method and a system for generating a composite video feed for a geographical area are disclosed. A video of the geographical area, captured by a camera, of an aerial platform is received. The video includes metadata indicative of location information, which is used to identify the coordinates of the geographical area. An image that is adjacent to the geographical area is received from the geographical information system and is transformed according to the metadata. The coordinates of the geographical area are used to determine an area with the image. The video is embedded in the area by matching the area with the coordinates of the geographical area, where the edges of the video correspond to the boundaries of the area. A composite video feed, including the video embedded along with the image, is generated and a video player displays the composite video feed.

In another embodiment, a method for generating a composite video feed for a geographical area is disclosed. A video of the geographical area captured by an aerial platform is received. Metadata, indicative of location information associated with the video, is processed. Coordinates of the geographical area are identified based on the location information. An image is received from a geographical information system (GIS), where the image is adjacent to the geographical area. The image is transformed according to the metadata. An area within the image is determined based on the coordinates of the geographical area. The video is embedded in the area by matching the area and the coordinates of the geographical area, where edges of the video correspond to boundaries of the area. The composite video feed with the video embedded along with the image is generated. A video player is caused to display the composite video feed.

In still embodiment, a system for generating a composite video feed for a geographical area is disclosed. The system comprises a video processor configured to:

receive a video of the geographical area captured by an aerial platform;

process metadata indicative of location information associated with the video; and

identify coordinates of the geographical area based on the location information;

The system further comprises an integrator that is configured to receive an image from a geographical information system (GIS), wherein the image is adjacent to the geographical area.

The video processor is further configured to:
transform the image according to the metadata;
determine an area within the image based on the coordinates of the geographical area; and
embed the video in the area by matching the area and the coordinates of the geographical area, wherein edges of the video correspond to boundaries of the area; and

The system further comprises a feed generator that is configured to:

generate the composite video feed with the video embedded along with the image; and

cause a video player to display the composite video feed.

Further areas of applicability of the present disclosure will become apparent from the detailed description provided hereinafter. It should be understood that the detailed description and specific examples, while indicating various embodiments, are intended for purposes of illustration only and are not intended to necessarily limit the scope of the disclosure.

### BRIEF DESCRIPTION OF THE DRAWINGS

The present disclosure is described in conjunction with the appended figures:

FIG. 1 illustrates a schematic representation of a military environment according to an embodiment of the present disclosure;

FIG. 2 illustrates a block diagram showing a stream processor according to an embodiment of the present disclosure;

FIG. 3 illustrates a top view of a landscape according to an embodiment of the present disclosure;

FIG. 4 illustrates a 3D video feed of a geographical area according to an embodiment of the present disclosure;

FIG. 5 illustrates a composite video feed of the geographical area according to an embodiment of the present disclosure;

FIG. 6 illustrates a flowchart of a method for generating a composite video feed according to an embodiment of the present disclosure; and

FIG. 7 illustrates a flowchart of a method for generating a composite video feed according to another embodiment of the present disclosure.

In the appended figures, similar components and/or features may have the same reference label. Further, various components of the same type may be distinguished by following the reference label by a second alphabetical label that distinguishes among the similar components. If only the first reference label is used in the specification, the description is applicable to any one of the similar components having the same first reference label irrespective of the second reference label.

### DETAILED DESCRIPTION

The ensuing description provides preferred exemplary embodiment(s) only, and is not intended to limit the scope, applicability or configuration of the disclosure. Rather, the ensuing description of the preferred exemplary embodiment(s) will provide those skilled in the art with an enabling description for implementing a preferred exemplary embodiment. It is understood that various changes may be made in the function and arrangement of elements without departing from the spirit and scope as set forth in the appended claims.

Embodiments described herein are generally related to a method and a system for generating a composite video feed for a geographical area. In particular, some embodiments of the disclosure describe processes for capturing a video via an aerial platform in a military environment. The disclosure specifically indicates receiving the video with metadata and an image from geographical information system (GIS) corresponding to the metadata. The metadata includes location information, which is either or together the location information of the geographical area and the location information of the aerial platform. The disclosure further describes about embedding of the captured video in the image along with overlaying geo-tag data on the video. For performing the embedding process a specific area on the image is determined based on the location information of the geographical area in the video. Further, the pixels of the area are replaced with the pixels of the video in the image. Upon embedding a video player plays a composite video feed at a full frame rate.

The presentation of the video helps a user, in particular a trainee soldier, to train in a simulating environment designed according to a battlefield to accurately identify physical objects in the geographical area. As the video is played at the full frame rate, a greater situational awareness is provided to the user to enable swift responses related to any asynchronous events in the geographical area.

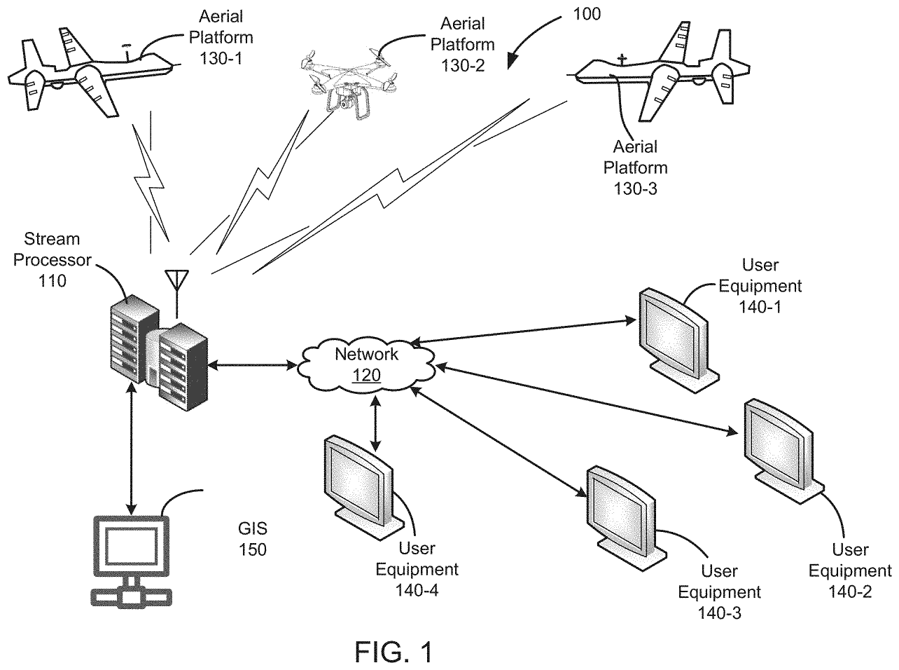

Referring to FIG. 1, illustrates a military environment 100 that includes elements for generating a composite video feed for a geographical area. The military environment 100 includes a stream processor 110, three aerial platforms 130-1, 130-2, 130-3, a communication network 120, four user equipment 140-1, 140-2, 140-3, 140-4, and a Geographical Information System (GIS) 150.

In the military environment 100 various programs may be dedicated for training soldiers or other civic personnel. One of the programs may relate to identification of a geographical area with specific details of physical objects present in the geographical area. For this, a video is captured via the three aerial platforms 130-1, 130-2, and 130-3. The aerial platforms 130-1, 130-2, and 130-3 are moving vehicles, such as airplanes, drones, or the like. The aerial platforms 130-1, 130-2, and 130-3 use a camera and other onboard electrical components to capture video of the geographical area and transmit video feed via the communication network 120 to various user equipment 140-1, 140-2, 140-3 for display. The video feed is transmitted to a stream processor 110 for analysis. The stream processor 110 is a command center, operations room, control outpost, or the like. The stream processor 110 works in combination with the GIS 150 for performing video processing and analysis in real-time The GIS 150 utilizes various geospatial tools for collaborating with the stream processor 110 in order to provide GIS image and Geo-tag data. The GIS 150 further includes an integrated database to provide the GIS image and the Geo-tag data in accordance with the geographical area of the video feed. The communication network 120 can be a wide area network (WAN). The WAN may comprise one or more public and/or private data communication networks, including the Internet, one or more cellular, radio, or other wireless WANs (WWANs), and/or the like.

The aerial platforms 130 includes multiple sensors to create metadata indicative of the location of the geographical area captured in the video. The metadata provides geographical coordinates of the physical objects within the frame of the video. Further, the sensors are designed to generate raw sensor data. The sensors are selected from a Global Navigation Satellite System GNSS) receiver (e.g., a Global Positioning System (GPS) receiver), magnetometer, altimeter, gyroscope, accelerometer, and/or the like, and may be generally indicative of a location of the geographical area in the video as well as elevation, azimuth, and orientation of the camera capturing video.

In some embodiments, the sensor data is embedded into the video feed in accordance with governing standards and protocols. The standards are protocols are dependent on various jurisdictions. For example, a Motion Imagery Standards Board (MISB) standard 0601 is one such standard indicating how sensor data is embedded into the video (e.g., as a real-time, synchronous MISB key-length-value (KLV) stream). In some other embodiments, alternative standards may be used depending on functionality.

In some embodiments, the stream processor 110 is designed to identify an error in the metadata of the video feed. In some embodiments, the stream processor 110 is configured to receive the video from the aerial platform 130 and GIS data from the GIS 150 and forward the video and the GIS data to the user equipment 140 to initiate further processing and generation of composite video and displaying of the composite video on the user equipment 140.

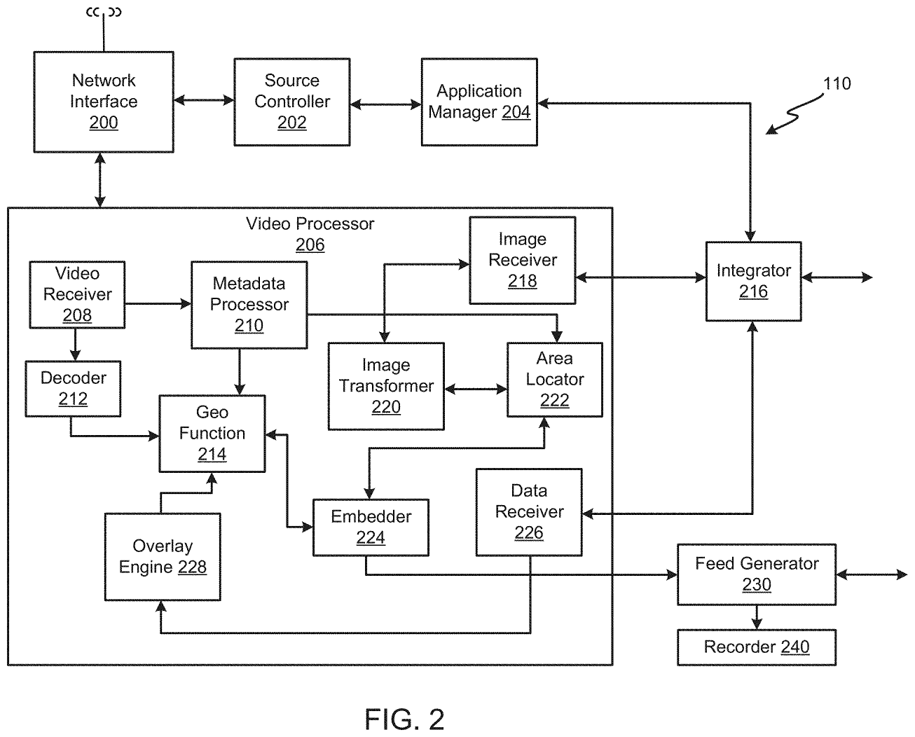

Referring to FIG. 2, illustrates a block diagram of the stream processor 110 as described in FIG. 1. The stream processor 110 includes a network interface 200, a source controller 202, an application manager 204, a video processor 206, a video receiver 208, a metadata processor 210, a decoder 212, a geo function 214, an integrator 216, an image receiver 218, an image transformer 220, an embedder 224, a data receiver 226, an overlay engine 228, a feed generator 230, and a recorder 240.

The aerial platform 130 communicates with the stream processor 110 via a network interface, where the source controller 202 is configured to select the aerial platform 130 from a plurality of aerial platforms 130-1, 130-2, and 130-2. The source controller 202 is further configured to calibrate the aerial platform with respect to altitude, speed, and location of the aerial platform, and the field of view (FOV) of the camera. The calibration is performed either on the ground or in flight prior to capturing the video. The source controller 202 used herein a source controller is a built-in computer or chipset or processor, which functions in combination with the application manager 204. The application manager 204 is a user interface that executes processes of both stream processor 110 and the aerial platform 130. In some embodiments, the application manager 204 works external to the stream processor 110, for example, at the user equipment 140. The application manager 204 provides communication connectivity between various applications at the stream processor 110 and the aerial platform 130. The network interface 200 also communicates with the video processor 206. The video processor 206 comprises the video receiver 208 to receive the video of the geographical area captured by the aerial platform 130. The video processor 206 further comprises the metadata processor 210 to process metadata indicative of location information associated with the video. In some embodiments, the metadata includes location information of the aerial platform 130 of the geographical area captured in the video, and elevation and azimuth with respect to the FOV of the camera. The aerial platform 130 captures the video and embeds the metadata and decodes the video in a particular video format, for which the decoder 212 is utilized in the stream processor 110 to decode the video. The geo function 214 receives location information from the metadata processor 210 and the decoder to identify coordinates of the geographical area based on the location information.

The integrator 216 is configured to receive GIS image and GIS data from the GIS 150. The GIS image is adjacent to the geographical area. In some embodiments, the image is a 2-D image of area surrounding the geographical area captured in the video. The video processor 206 further comprises the image transformer 220 to transform the image according to the metadata. In some embodiments, the image is transformed by rotating the image, skewing or de-skewing the image, changing orientation, and scaling the image to match a particular size of the video. In some other embodiments, the image is transformed from 2-D to 3-D by applying a homographic matrix for viewing the image according to an optical perspective of the camera. In some other embodiments, the video processor 206 corrects the metadata of the video to counter distortion generated due to obstructions within an optical path of the camera and due to the transformation. The area locator 222 determines an area within the image based on the coordinates of the geographical area. The embedder 224 receives the information from the area locator 222 and geo function 214 to embed the video in the area by matching the area and the coordinates of the geographical area. In some embodiments, the video is embedded in the area by replacing pixels of the area with pixels of the video. The edges of the video correspond to the boundaries of the area. The embedder 224 forwards the embedded video in the image to the feed generator 230 to generate the composite video feed with the video embedded along with the image. The video processor 206 causes a video player to display the composite video feed. In some embodiments, the video player function in the user equipment 140.

The data receiver 226 is communicatively coupled to the integrator 216 to receive the GIS data. The GIS data includes the geo-tagging information that is forwarded to the overlay engine 228. The geo function 214 uses the geo-tagging information from the overlay engine 228 to overlay geo-tagging information on the composite video feed, where the feed generator 230 is further configured to generate a composite video feed with the geo-tagging information. The video processor is further configured to cause the video player to display the composite video feed at a full-frame rate. The full-frame rate is the upper limit of the frame rate supported by the user equipment 140. In some embodiments, the recorder 240 is configured to record the composite video feed for a pre-defined duration.

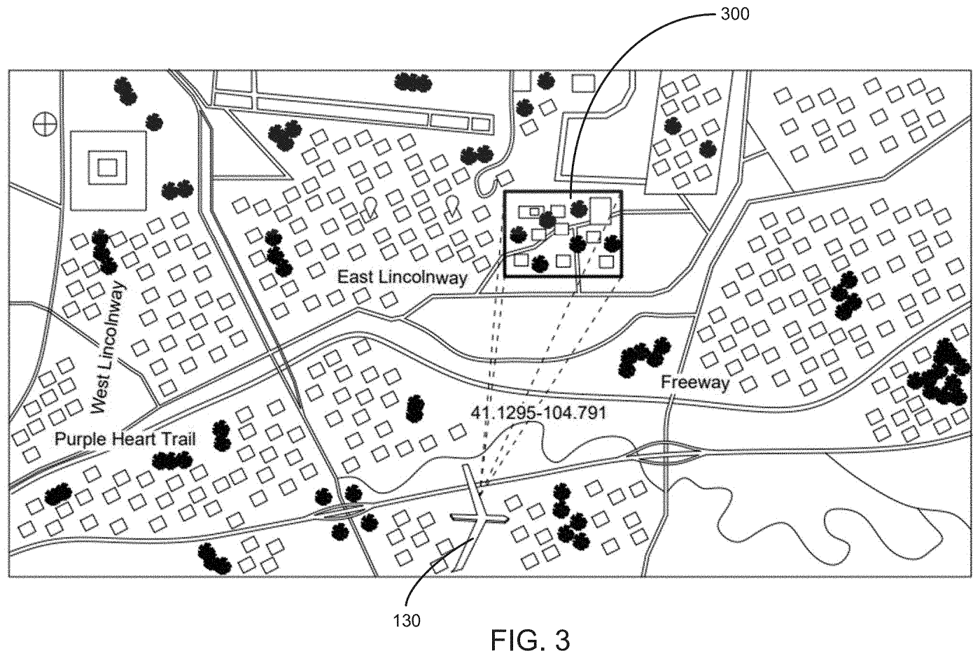

Referring to FIG. 3, illustrates a top view of a landscape according to an embodiment of the present disclosure. The view shows the aerial platform 130 capturing the video of the geographical area at an angled overhead view of the geographical area comprising a grid of city streets. As illustrated, the aerial platform 130 is depicted along with scan lines (dashed lines) to mark the geographical area 300. The aerial platform 130 includes a drone, airplane, etc. Sensors on the aerial platform 130 are used to capture metadata about the geographical area. The metadata is embedded in the video. In some embodiments, the metadata includes geographical coordinates corresponding to a center and/or the four corners of the video.

The GIS 150 is configured to generate map information that is overlayed as a graphical representation of the video. As illustrated, the landscape comprises a graphical representation corresponding to physical features in the geographical area, such as roads and intersections. Depending on functionality, available map information, and/or other factors, graphical representations of other types of physical structures in the geographical area may be depicted additionally or alternatively.

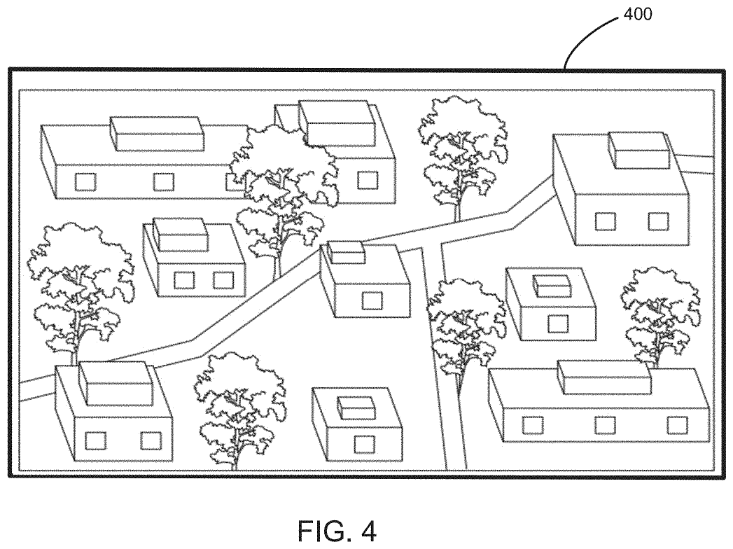

Referring to FIG. 4, illustrates a 3D video feed 400 of a geographical area according to an embodiment of the present disclosure. According to some embodiments, the 3D video feed 400 comprises a live video at a full frame rate, which is dynamically updated based on new camera angles or perspectives. In other words, stream processor 110 obtains location information from the metadata for an image within the video feed to determine the geographical area falling within the frame of that image. The stream processor 110 can then retrieve the map data relevant to the geographical area and create overlay geo-tag information on the video.

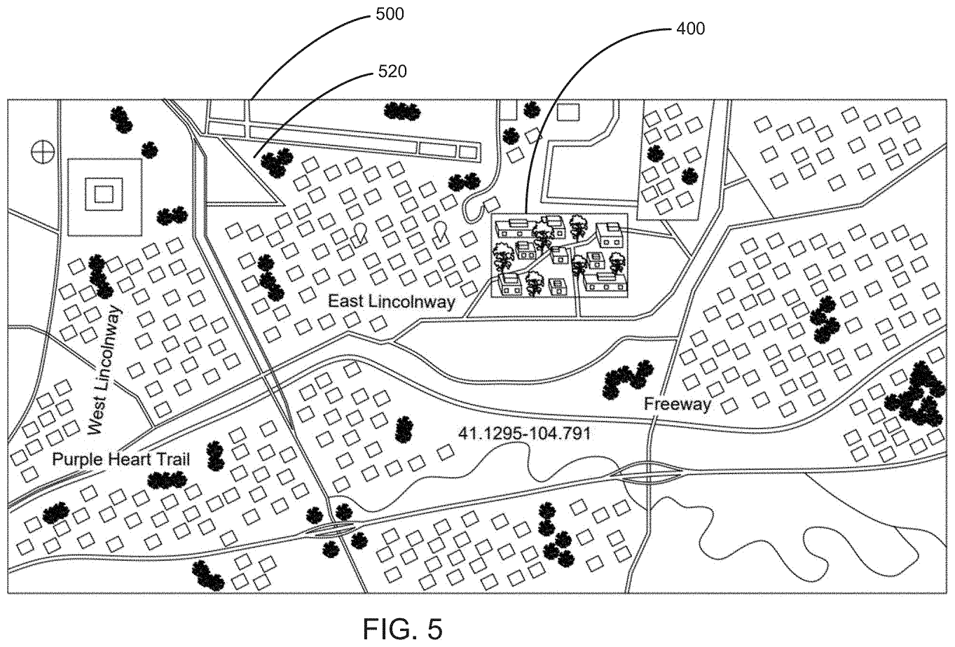

Referring to FIG. 5, illustrates a composite video feed 500 of the geographical area according to an embodiment of the present disclosure. According to embodiments, the user is able to view the combined visualization of the video 400 and a GIS image 520. The GIS image 520 is transformed according to the metadata. In some embodiments, the GIS image 520 is transformed by rotating the image, skewing or de-skewing the image, changing orientation and scaling of the image to match a particular size of the video. In some other embodiments, GIS image 520 is transformed from 2-D to 3-D by applying a homographic matrix for viewing the GIS image 520 according to an optical perspective of the camera. Further, an area corresponding to the geographical area is located in the GIS image 520. The video 400 is embedded in the area by matching the area and the coordinates of the geographical area. In some embodiments, the video is embedded in the area by replacing pixels of the area with pixels of video 510. The edges of video 400 correspond to the boundaries of the area. The composite video feed 500 is generated with the video 400 embedded along with the GIS image 520 and the video player is caused to display the composite video feed. In some embodiments, the video player functions in the user equipment 140. In some embodiments, the video player shows the composite video feed with a graphical representation of physical features, such as roads, intersections, rivers, and residential societies overlaid on video 400.

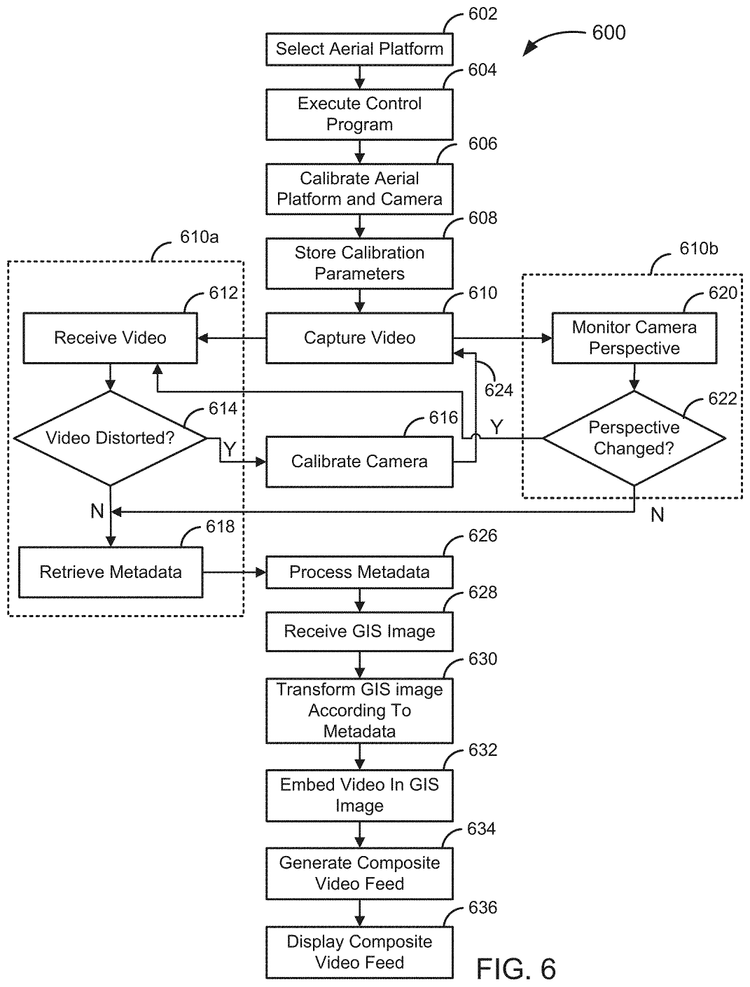

Referring to FIG. 6, illustrates a flowchart of method 600 for generating a composite video feed according to an embodiment of the present disclosure. Some blocks of method 600 may be performed by the stream processor 110 and by utilizing processing resources through any suitable hardware, non-transitory machine-readable medium, or a combination thereof.

At block 602, an aerial platform 130 is selected out of a plurality of aerial platforms as shown in FIG. 1. The aerial platform 130 is selected based on the current location and flight path of the aerial platform 130. In some embodiments, a user may provide instructions to the aerial platform for moving to different paths. In some other embodiments, the user may operate the aerial platform via the user equipment 160. In other words, a user may provide instructions to the stream processor 110 to enable the source controller 202 to operate and control the aerial platform 130.

At block 604, a control program, designed to operate the selected aerial platform 130, is executed. The control program has a series of instructions that may be selected by the user in order to control and operate the aerial platform 130.

At block 606, the aerial platform 130 and a camera associated with the aerial platform 130 are calibrated such that the aerial platform 130 flies over a geographical area and the camera is able to capture the video of the geographical area.

At block 608, calibration parameters associated with the aerial platform 130 and the camera are stored in a database, so that the parameters can be checked and can be referred to at a later stage of the video-capturing process. In some embodiments, the user may provide instructions to the aerial platform 130 to change the flight path and move to a different location. In some other embodiments, the user may provide instructions to change the camera focus or camera angle in order to counter distortion generated in an optical path of the camera.

At block 610, a video of the geographical area is captured. The captured video includes multiple frames and associated metadata. The metadata may include location information of the geographical area and location information of the physical objects present in the geographical area. In some embodiments, the metadata may also include information related to azimuth, elevation, and information related to other angles of the camera. Upon video capture, the video undergoes two sub-processes (610a and 610b). One of the subprocesses is named distortion correction stage 610a and the other subprocess is named camera monitoring stage 610b.

At block 612, the captured video is received by the video receiver 208 of the stream processor 110.

At block 614, the received video is checked for distortion due to improper focus of the camera on the geographical region or distortion due to obstruction in an optical path of the camera towards the geographical area. The obstruction may occur due to climatic conditions, such as rain or fog.

At block 616, upon identifying distortion in the video, the camera is calibrated, and the video is captured again after calibration. In some embodiments, the user may provide instruction to the aerial platform 130 for displacement to a nearby flight space that may also be capable to provide video of the geographical area but maybe with a different camera angle. In this manner, the video is dynamically updated for correcting any distortions that may have occurred at the time of capturing the video.

At block 618, upon identifying no distortion in the video, the metadata is retrieved by the stream processor 110.

At block 620, and referring to the camera monitoring stage 610b, the perspective of the camera is continually monitored while the video is received by the video receiver 208. For example, the aerial platform while flying may provide a live video feed from multiple camera perspectives In this case, individual camera angle may provide a different view of the geographical area captured in the video.

At block 622, a change in the camera perspective is identified based on a change in qualifying parameters as compared to the calibration parameters associated with the aerial platform 130 and the camera is stored in the database.

At block 624, upon identifying the change in the perspective of the camera, the video is re-captured. In this manner, the video is dynamically updated for correcting any distortions that may have occurred at the time of capturing the video due to changes in the camera perspective.

At block 626, upon identifying no change in the camera perspective, the retrieved metadata is processed. The metadata is inclusive of the location coordinates of the geographical area.

At block 628, an image from a geographical information system (GIS) is received. The image is received based on the location coordinates of the geographical area, where the image is of the surrounding area of the geographical area.

At block 630, the image is transformed according to the metadata. In some embodiments, the image is transformed by rotating the image, skewing or de-skewing the image, changing orientation, and scaling the image to match a particular size of the video. In some other embodiments, the image is transformed from 2-D to 3-D by applying a homographic matrix for viewing the image according to an optical perspective of the camera. Further, an area corresponding to the geographical area is located in the image.

At block 632, the video is embedded in the area by matching the area and the coordinates of the geographical area. In some embodiments, the video is embedded in the area by replacing pixels of the area with pixels of the video. The edges of the video correspond to the boundaries of the area.

At block 634, a composite video feed is generated with the video embedded along with the image.

At block 636, a video player is caused to display the composite video feed. In some embodiments, the video player functions in the user equipment 140. In some embodiments, the video player shows the composite video feed with a graphical representation of physical features, such as roads, intersections, rivers, and residential societies overlaid on the video.

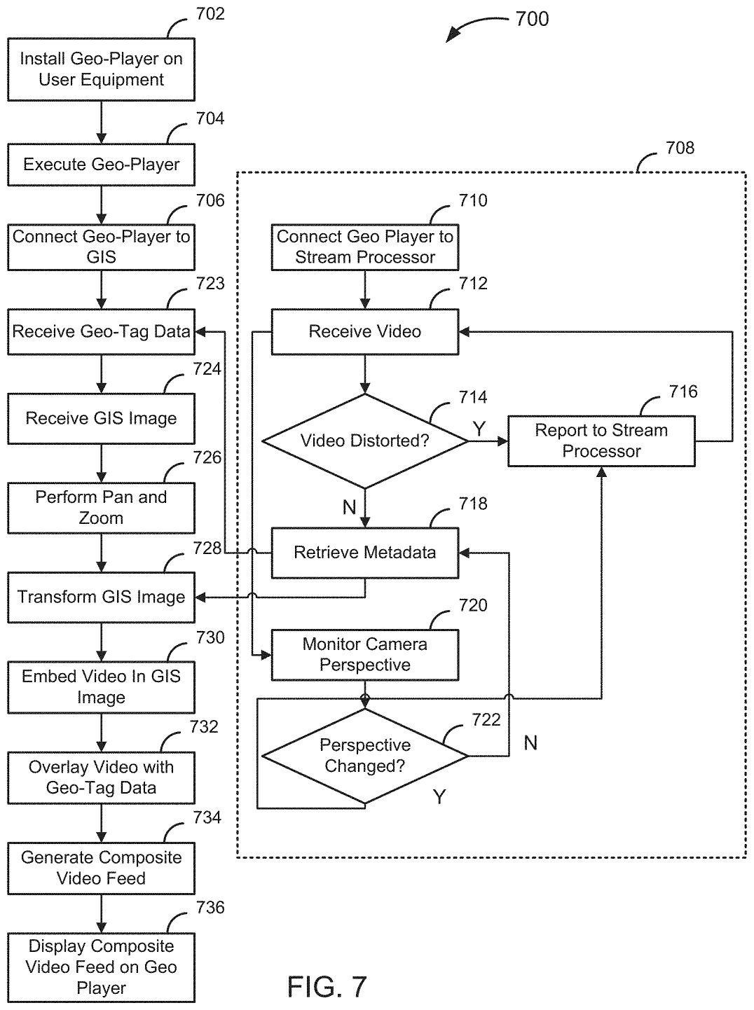

Referring to FIG. 7, illustrates a flowchart of method 700 for generating a composite video feed according to another embodiment of the present disclosure. Some blocks of method 700 may be performed by the stream processor 110 and by utilizing processing resources through any suitable hardware, non-transitory machine-readable medium, or a combination thereof.

At block 702, a geo player is installed on the user equipment 140. In some embodiments, the geo-player is associated with the GIS 150, where the geo-player is configured to receive the composite video feed along with geo-tag information associated with the geographical area. In some other embodiments, an integrated database of the GIS 150 provides processed geo-tag information corresponding to the metadata of the video received by the stream processor 110. In the embodiments of FIG. 7, the stream processor 110 functions externally to the user equipment 140. However, in some other embodiments, the stream processor 110 is integrated into the user equipment 140. In some embodiments, the geo-player is similar to the video player of FIG. 2. In an example, the geo-player may be loaded directly on a web browser.

At block 704, the geo-player is executed on the user equipment to enable a user interface of the geo-player.

At block 706, the geo player is connected to the GIS 150 to communicate with the integrated database of the GIS 150. Simultaneous with connecting to the GIS 150, a stream processing stage 708 is enabled.

At block 710, the geo-player is connected to the stream processor 110.

At block 712, the captured video is received by the geo-player.

At block 714, the received video is checked for distortion due to improper focus of the camera on the geographical region or distortion due to obstruction in an optical path of the camera towards the geographical area. The obstruction may occur due to climatic conditions, such as rain or fog.

At block 716, upon identifying distortion in the video, a report is generated for the stream processor 110 to correct parameters for countering distortions and receive a new video.

At block 718, upon identifying no distortion in the video, the metadata is retrieved by the user equipment 140.

At block 720, a perspective of the camera is continually monitored while the video is received by the geo player.

At block 722, a change in the camera perspective is identified based on a change in qualifying parameters as compared to the calibration parameters associated with the aerial platform 130 and the camera is stored in the database. Upon identifying the change in the perspective of the camera, a notification is generated for the stream processor 110 to receive a new video and upon identifying no change in the camera perspective, the metadata is retrieved by the user equipment 140.

At block 723, geo-tag data is retrieved from the GIS 150 based on the retrieved metadata.

At block 724, an image from the GIS 150 is received. The image is received based on the location coordinates of the geographical area present in the metadata, where the image is of the surrounding area of the geographical area.

At block 726, pan and zoom operation is performed on the image to identify the geographical area according to the metadata.

At block 728, the image is transformed according to the metadata. In some embodiments, the image is transformed by rotating the image, skewing or de-skewing the image, changing orientation, and scaling the image to match a particular size of the video. In some other embodiments, the image is transformed from 2-D to 3-D by applying a homographic matrix for viewing the image according to an optical perspective of the camera. Further, an area corresponding to the geographical area is located in the image.

At block 730, the video is embedded in the area by matching the area and the coordinates of the geographical area. In some embodiments, the video is embedded in the area by replacing pixels of the area with pixels of the video. The edges of the video correspond to the boundaries of the area.

At block 732, In some embodiments, a graphical representation of physical features, such as roads, intersections, rivers, and residential societies overlaid on the video.

At block 734, a composite video feed is generated with the video embedded along with the image and the graphical representation.

At block 736, the geo player is caused to display the composite video feed.

The present embodiments described herein related to the system and the method for generating the composite video feed for the geographical area enables a user to watch the video feed on any video player, where the video feed is provided along with geo-tag information in a same frame rate as it was recorded. This enables the user to easily track asynchronous events happening in the geographical area in real-time. The user or a trainee can therefore have great situational awareness, especially when functioning in the military environment.

Specific details are given in the above description to provide a thorough understanding of the embodiments. However, it is understood that the embodiments may be practiced without these specific details. For example, circuits may be shown in block diagrams in order not to obscure the embodiments in unnecessary detail. In other instances, well-known circuits, processes, algorithms, structures, and techniques may be shown without unnecessary detail in order to avoid obscuring the embodiments.

Implementation of the techniques, blocks, steps and means described above may be done in various ways. For example, these techniques, blocks, steps and means may be implemented in hardware, software, or a combination thereof. For a hardware implementation, the processing units may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described above, and/or a combination thereof.

Also, it is noted that the embodiments may be described as a process which is depicted as a flowchart, a flow diagram, a swim diagram, a data flow diagram, a structure diagram, or a block diagram. Although a depiction may describe the operations as a sequential process, many of the operations can be performed in parallel or concurrently. In addition, the order of the operations may be re-arranged. A process is terminated when its operations are completed, but could have additional steps not included in the figure. A process may correspond to a method, a function, a procedure, a subroutine, a subprogram, etc. When a process corresponds to a function, its termination corresponds to a return of the function to the calling function or the main function.

Furthermore, embodiments may be implemented by hardware, software, scripting languages, firmware, middleware, microcode, hardware description languages, and/or any combination thereof. When implemented in software, firmware, middleware, scripting language, and/or microcode, the program code or code segments to perform the necessary tasks may be stored in a machine readable medium such as a storage medium. A code segment or machine-executable instruction may represent a procedure, a function, a subprogram, a program, a routine, a subroutine, a module, a software package, a script, a class, or any combination of instructions, data structures, and/or program statements. A code segment may be coupled to another code segment or a hardware circuit by passing and/or receiving information, data, arguments, parameters, and/or memory contents. Information, arguments, parameters, data, etc. may be passed, forwarded, or transmitted via any suitable means including memory sharing, message passing, token passing, network transmission, etc.

For a firmware and/or software implementation, the methodologies may be implemented with modules (e.g., procedures, functions, and so on) that perform the functions described herein. Any machine-readable medium tangibly embodying instructions may be used in implementing the methodologies described herein. For example, software codes may be stored in a memory. Memory may be implemented within the processor or external to the processor. As used herein the term “memory” refers to any type of long term, short term, volatile, nonvolatile, or other storage medium and is not to be limited to any particular type of memory or number of memories, or type of media upon which memory is stored.

Moreover, as disclosed herein, the term “storage medium” may represent one or more memories for storing data, including read only memory (ROM), random access memory (RAM), magnetic RAM, core memory, magnetic disk storage mediums, optical storage mediums, flash memory devices and/or other machine readable mediums for storing information. The term “machine-readable medium” includes, but is not limited to portable or fixed storage devices, optical storage devices, and/or various other storage mediums capable of storing that contain or carry instruction(s) and/or data.

While the principles of the disclosure have been described above in connection with specific apparatuses and methods, it is to be clearly understood that this description is made only by way of example and not as limitation on the scope of the disclosure.

What is claimed is:

1. A method for generating a composite video feed for a geographical area, the method comprising:
receiving a video of the geographical area captured by an aerial platform;
processing metadata indicative of location information associated with the video;
identifying coordinates of the geographical area based on the location information;
receiving an image from a geographical information system (GIS), wherein the image is adjacent to the geographical area;
transforming the image according to the metadata;
determining an area within the image based on the coordinates of the geographical area;
embedding the video in the area by matching the area and the coordinates of the geographical area, wherein edges of the video correspond to boundaries of the area;
generating the composite video feed with the video embedded along with the image; and
causing a video player to display the composite video feed.

2. The method for generating the composite video feed for the geographical area as claimed in claim 1, the method further comprises:
selecting an aerial platform from a plurality of aerial platforms, wherein the aerial platform has a camera for capturing the video of the geographical area; and
prior to capturing the video, calibrating the aerial platform with respect to:
altitude, speed, and location of the aerial platform, and
a field of view (FOV) of the camera.

3. The method for generating the composite video feed for the geographical area as claimed in claim 2, wherein the metadata includes:
location information of the aerial platform of the geographical area captured in the video, and
elevation and azimuth with respect to the FOV of the camera.

4. The method for generating the composite video feed for the geographical area as claimed in claim 1, wherein the image is a 2-D image of area surrounding the geographical area captured in the video.

5. The method for generating the composite video feed for the geographical area as claimed in claim 1, wherein transforming the image includes rotating the image, skewing or de-skewing the image, changing orientation and scaling of the image to match a particular size of the video.

6. The method for generating the composite video feed for the geographical area as claimed in claim 1, wherein the method further comprises:
transforming the image from 2-D to 3-D by applying a homographic matrix for viewing the image according to an optical perspective of a camera; and
correcting metadata of the video to counter distortion generated due to obstructions within an optical path of the camera and due to the transformation.

7. The method for generating the composite video feed for the geographical area as claimed in claim 1, wherein the method further comprises:
generating geo-tagging information using the metadata;
overlaying the video with the geo-tagging information; and
generating a composite video feed with geo-tagging information.

8. The method for generating the composite video feed for the geographical area as claimed in claim 1, wherein embedding the video in the area includes replacing pixels of the area with pixels of the video.

9. The method for generating the composite video feed for the geographical area as claimed in claim 1, wherein the method further comprises causing the video player to display the composite video feed, at a full-frame rate.

10. The method for generating the composite video feed for the geographical area as claimed in claim 1, wherein the method further includes recording the composite video feed for a pre-defined duration.

11. A system for generating a composite video feed for a geographical area, the system comprising:
a video processor configured to:
receive a video of the geographical area captured by an aerial platform;
process metadata indicative of location information associated with the video; and
identify coordinates of the geographical area based on the location information;
an integrator configured to receive an image from a geographical information system (GIS), wherein the image is adjacent to the geographical area;
wherein the video processor is further configured to:
transform the image according to the metadata;
determine an area within the image based on the coordinates of the geographical area; and
embed the video in the area by matching the area and the coordinates of the geographical area, wherein edges of the video correspond to boundaries of the area; and
a feed generator configured to:
generate the composite video feed with the video embedded along with the image; and
cause a video player to display the composite video feed.

12. The system for generating the composite video feed for the geographical area of claim 11, wherein the video processor is further configured to:
select an aerial platform from a plurality of aerial platforms, wherein the aerial platform has a camera for capturing the video of the geographical area; and
prior to capturing the video, calibrate the aerial platform with respect to:
altitude, speed, and location of the aerial platform, and; and
a field of view (FOV) of the camera.

13. The system for generating the composite video feed for the geographical area of claim 12, wherein the metadata includes:
location information of the aerial platform of the geographical area captured in the video, and; and
elevation and azimuth with respect to the FOV of the camera.

14. The system for generating the composite video feed for the geographical area of claim 11, wherein the image is a 2-D image of area surrounding the geographical area captured in the video.

15. The system for generating the composite video feed for the geographical area of claim 11, wherein transforming the image includes rotating the image, skewing or de-skewing the image, changing orientation and scaling of the image to match a particular size of the video.

16. The system for generating the composite video feed for the geographical area of claim 11, wherein the video processor is further configured to:
transform the image from 2-D to 3-D by applying a homographic matrix for viewing the image according to an optical perspective of a camera; and
correct metadata of the image to counter distortion generated due to obstructions within an optical path of the camera and due to the transformation.

17. The system for generating the composite video feed for the geographical area of claim 11, wherein the video processor is further configured to:
generate geo-tagging information using the metadata; and
overlay the video with the geo-tagging information;
wherein the feed generator is further configured to generate a composite video feed with the geo-tagging information.

18. The system for generating the composite video feed for the geographical area of claim 11, wherein embedding the video in the area includes replacing pixels of the area with pixels of the video.

19. The system for generating the composite video feed for the geographical area of claim 11, wherein the video processor is further configured to cause the video player to display the composite video feed, at a full-frame rate.

20. The system for generating the composite video feed for the geographical area of claim 11, wherein the system further comprises a recorder to record the composite video feed for a pre-defined duration.
